(19) United States
(12) Patent Application Publication
(10) Pub. No.: US 2007/0257058 A1
(43) Pub. Date: Nov. 8, 2007

(54) Wall plate system with releasable lock

(76) Inventors: Heiner Ophardt, Vineland (CA); Kevin T. Lightfoot, Oakville (CA); Andrew Jones, St. Catharines (CA)

Correspondence Address: RICHES, MCKENZIE & HERBERT, LLP, SUITE 1800, 2 BLOOR STREET EAST, TORONTO, ON, M4W 3J5, US

(21) Appl. No.: 11/790,730

(22) Filed: Apr. 27, 2007

(30) Foreign Application Priority Data
May 2, 2006 (CA) 2,545,654
Feb. 8, 2007 (CA) 2,578,422

(51) Int. Cl. B67D 5/56; B65D 35/22

(52) U.S. Cl. 222/129; 222/94

(57) ABSTRACT

A universal wall plate which can be secured to a wall and to which a variety of dispensers can readily be secured and removed with minimal effort, without the need to remove the wall panel and without causing damage to the wall.

### SCOPE OF THE INVENTION

This invention relates to a wall plate for mounting to a wall and upon which dispensers such as soap dispensers may be readily secured and removed.

### BACKGROUND OF THE INVENTION

In hospital environments, many different types of dispensers are mounted to walls, such as, liquid dispensers including soap dispensers and dispensers for alcohol cleaning solutions. Typical, such dispensers are mounted to walls by the use of fasteners, such as, screws with or without wall anchors and by the use of adhesives. A disadvantage of the use of screws is that holes are created in the wall by the screws themselves or by the anchors for the screws and that the anchors often remain embedded in the wall and are difficult to remove. In any event, the removal of the screws and/or the removal of the wall anchors causes damage to the wall and leaves unsightly holes. A disadvantage of the use of adhesives is that on removal of the dispenser from a wall, the surface of the wall which is typically painted or has some other form of wall covering is removed or marred or otherwise damaged in an unsightly manner. Not only for decorative reasons but also for sanitary reasons, it is preferred that any damage caused by the removal of a dispenser be repaired with resultant additional cost.

Many dispensers have a useful life after which they need to be replaced. Often times, the costs of removal of an existing dispenser, repair of the wall upon which is mounted and mounting of a new dispenser is a significant cost relative to the cost of a new dispenser.

### SUMMARY OF THE INVENTION

To at least partially overcome these disadvantages of previously known devices, the present invention provides a wall plate for mounting to a wall upon which wall plate dispensers may readily be secured and removed.

An object of the present invention is to provide a universal wall plate which can be secured to a wall and to which a variety of dispensers can readily be secured and removed with minimal effort, without the need to remove the wall panel and without causing damage to the wall. Another object is to provide a simplified arrangement for mounting and removing dispensers to a wall.

In accordance with the present invention, a wall plate system is provided for mounting dispensers to a wall. The system includes as components, a wall plate adapted for securing to the wall and one or more dispensers each of which are adapted to be removably coupled to the wall plate. The wall plate is secured to the wall and carries preferably at an upper end a securement portion as preferably an outwardly extending flange which carries engagement elements providing a quick connect and quick disconnect arrangement for interaction with an engagement member carried on each of the dispensers adapted to be coupled to the wall plate. The engagement member carried each of the dispensers is preferably provided at an upper end of the dispenser such that the dispenser may be engaged at its upper end to the outwardly extending flange and hang downwardly therefrom supported at its upper end. The engagement member may preferably be provided as an integral portion of the dispenser, as for example, as a portion of a plastic member forming a back plate of the dispenser. The engagement member may be a separate adaptor to be coupled to the dispenser as, for example, as a preferably thin member attached to the rear of the dispenser and providing the engagement member. While not necessary, preferably some means may be provided for attachment of a rear surface of the dispenser below its upper end to a plate portion of the wall plate which extends downwardly on the wall from the outwardly extending flange. Preferred arrangements can include magnets and releasable adhesives. The wall plate is to be relatively permanently secured to a wall as by fasteners, such as, screws with or without wall anchors or adhesives. Once the wall plate is attached to a wall, any dispenser having complementary engagement members may be easily coupled to the wall plate for use or uncoupled for replacement by the same dispenser or other dispensers having appropriate complementary engagement members.

A lock member may be provided which is adapted to be releasably coupled to the wall plate and when so coupled prevents disengagement between the engagement member and the engagement element.

The wall plate may have the securement portion formed with a hollow channel extending therethrough open at each side edge of the wall plate. A plug member may be provided to block passage through the channel as with the plug member being secured in the channel against removal while the wall plate is secured to the wall preferably permitting the plug member to be secured to the wall plate while the wall plate is secured to the wall.

The wall plate may have a number of engagement elements so as to permit more than one dispenser to be provided on the wall plate, or any one dispenser to be coupled by two or more engagement members.

The nature of the dispensers are preferably to be selected from: soap dispensers as for washing hands as in a washroom context; fluid dispensers for dispensing, cleaning and disinfecting solutions, such as, alcohol based solutions for use by medical personnel in hospitals; dispensers of paper towels and serviettes for drying hands; and dispensers of air freshener. However, the wall plate may be used for mounting and demounting any manner of devices which may be desired to be secured to a wall and may reasonably be expected to be removed as for repair or replacement, particularly, where the replacement may have a different foot print. Such devices include smoke and fire alarms, thermometers, and fire extinguishers.

In one aspect, the present invention provides a wall plate system comprising: a wall plate adapted for securing to a wall by fastening mechanism selected from fasteners which extend rearwardly of the wall plate into the wall and adhesives, a plurality of dispensers each of which are adapted to be removably coupled to the wall plate, the wall plate having an upper edge, a lower edge, and two side edges, the wall plate having a securement portion and a plate portion, the securement portion disposed along the upper edge, the plate portion coupled to the securement portion and extending therefrom between the two side edges to the lower edge, the plate portion comprising a thin planar sheet member having a rear surface and a front surface, the securement portion having a rear surface disposed in the same plane as the rear surface of the plate portion or forward thereof, the securement portion carrying an engagement element, the dispenser having an upper end, a lower end and a rear surface for engagement with forward surface of the plate portion, the dispenser carrying at its upper end an engagement member removably engaging the engagement element of the securement portion to removably secure the dispenser to the wall plate with the rear surface of the dispenser in engagement with the forward surface of the plate portion with the upper end of the dispenser proximate the securement portion and with the dispenser extending downwardly from its upper end to its lower end, wherein with the wall plate secured to a wall with a first of the dispensers coupled to the wall plate by engagement between the engagement element of the wall plate and the engagement member of that first dispenser, without removal or disengagement of the wall plate from the wall, the first dispenser is removable from the wall plate by disengagement of the engagement between the engagement element of the wall plate and the engagement member of that first dispenser for replacement as by a second of the plurality of dispensers by engagement between the engagement element of the wall plate and the engagement member of that second dispenser.

### BRIEF DESCRIPTION OF THE DRAWINGS

Further aspects and advantages of the present invention will become apparent from the following description taken together with the accompanying drawings in which:

FIG. 1 is an exploded perspective view of a wall plate system in accordance with a first embodiment of the present invention;

FIG. 2 is a perspective view showing the wall plate system of FIG. 1 with the dispenser secured to the wall plate;

FIG. 3 is a schematic vertical cross-sectional side view along section line 3-3′ in FIG. 2;

FIG. 4 is an enlarged view of a portion of FIG. 3 but showing merely the wall plate and wall;

FIG. 5 is an exploded perspective view showing an adaptor plate together with a back plate for a dispenser in accordance with a second embodiment;

FIG. 6 is a pictorial view of a third embodiment of a T-shaped key member;

FIG. 7 is a side view similar to FIG. 4 but showing the key member of FIG. 6;

FIG. 8 is a side view similar to FIG. 7 but showing insertion of the key member of FIG. 6;

FIG. 9 is a schematic pictorial view of a wall plate and dispenser back plate in accordance with a fourth embodiment of the invention assembled;

FIG. 10 is a side view of the embodiment of FIG. 9 being assembled;

FIG. 11 is a perspective view of a wall plate system in accordance with a fifth embodiment of the present invention;

FIG. 12 is an enlarged perspective view of a portion of the wall plate system shown in FIG. 11;

FIG. 13 is an enlarged rear perspective view of the upper rear end of the key member of the back plate of the dispenser shown in FIG. 11;

FIG. 14 is a cross-sectional side view of FIG. 12, however, merely showing the upper portions of the wall plate and a back plate;

FIG. 15 is a side view the same as shown in FIG. 14, however, also showing a lock member;

FIG. 16 is a front perspective view of the lock member shown in FIG. 12;

FIG. 17 is a perspective rear view of the lock member shown in FIG. 16 as seen from above;

FIG. 18 is a top view of the lock member shown in FIG. 16;

FIG. 19 is a perspective rear view of the lock member shown in FIG. 16 as seen from below;

FIG. 20 is a rear view of the lock member shown in FIG. 16 with a catch arm in an unbiased rest position;

FIG. 21 is a rear view the same as in FIG. 20, however, showing a tool urging the catch arm in a retracted position;

FIG. 22 is a schematic pictorial rear view showing the lock member secured on the wall plate;

FIG. 23 is a partial front perspective view showing the lock member secured to the wall plate and a lever tool disposed spaced therefrom ready for engagement with the lock member;

FIG. 24 is a front perspective view similar to that in FIG. 23 but with the lever tool engaging the lock member as in FIG. 21;

FIG. 25 is a vertical cross-sectional side view of FIG. 23 through the middle of the lock member;

FIG. 26 is a vertical cross-sectional side view of FIG. 24 through the middle of the lock member;

FIG. 27 is a perspective front view of a plug member shown in FIG. 12;

FIG. 28 is a perspective rear view of the plug member of FIG. 27;

FIG. 29 is a front view of the plug member of FIG. 27;

FIG. 30 is a top view of the plug member of FIG. 27;

FIG. 31 is an end view of the plug member of FIG. 27;

FIG. 32 is a bottom view of the plug member of FIG. 27;

FIG. 33 is a rear view of the plug member of FIG. 27;

FIG. 34 is a partial front perspective view showing merely an upper corner of the wall plate and the plug member of FIG. 12;

FIG. 35 is a right side view of the wall plate and plug member shown in FIG. 34;

FIG. 36 is a rear perspective view of the wall plate and plug member shown in FIG. 33;

FIG. 37 is a side view the same as that shown in FIG. 33, however, also showing a latch member and key member as seen in FIG. 12.

### DETAILED DESCRIPTION OF THE DRAWINGS

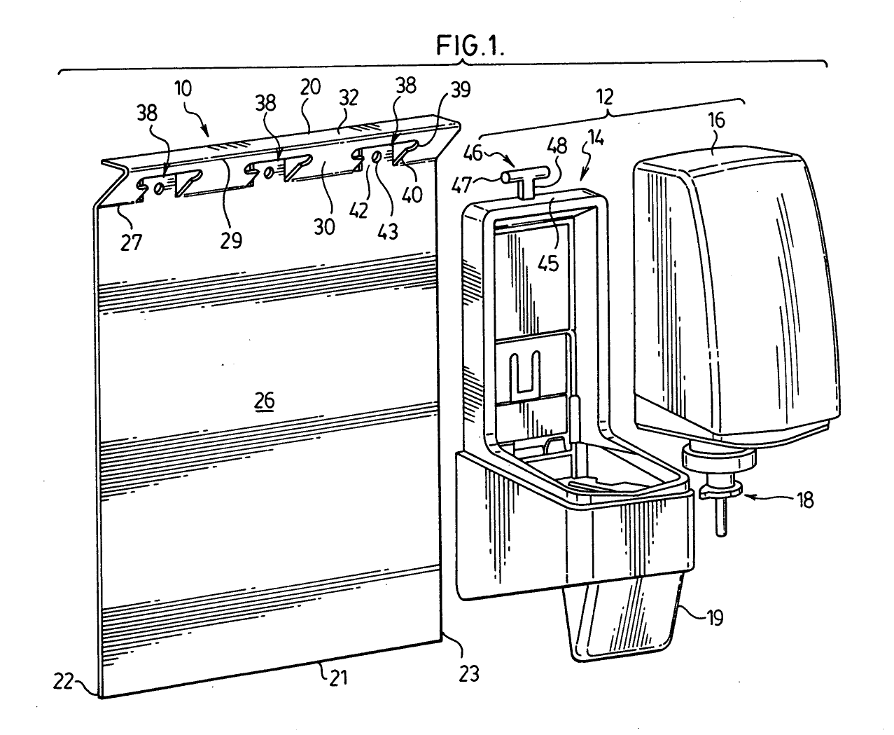

Reference is made first to FIG. 1 which illustrates an exploded view of the wall plate system in accordance with the present invention and including a wall plate 10 adapted for securing to a wall and a dispenser 12 adapted to be removably coupled to the wall plate 10. The dispenser 12 comprises a back plate 14 and a replaceable fluid reservoir 16 with an attached pump 18. In a known manner, the fluid reservoir 16 and pump 18 are removably coupled to the back plate 14 in a manner that manual rearward pressing on an actuation lever 19 will dispense fluid downwardly as on to the hand of a user below the dispenser.

The wall plate 10 has an upper edge 20, a lower edge 21 and two side edges 22 and 23. The wall plate 10 illustrated is formed from a unitary sheet of metal having a rear surface 24 and a forward surface 25. The wall plate 10 has a plate portion 26 which extends between the side edges 22 and 23 from the lower edge 21 to a first fold line 27. The wall plate 10 has a securement portion 28 which comprises the wall plate 10 from the first fold line 27 between the side edges 22 and 23 to the upper edge 20. The wall plate 10 extends from the first fold line 27 forwardly and upwardly at a diagonal to a plane in which the plate portion 26 lies to a second fold line 29 and hence from the second fold line 29 rearwardly and upwardly at an angle to the upper edge 20. The upper edge 20 is disposed in the same plane as a plane through the rear surface 24 of the plate portion 26.

The securement portion 28 is in the form of a channelway member extending longitudinally along the upper edge 20 of the wall plate open at its rear and closed at its front by a lower flange 30 between the first fold line 27 and the second fold line 29 and an upper flange 32 between the second fold line 29 and the upper edge 20. The securement portion 28 as such a channelway member defines a channelway 34 therein open rearwardly but however to be closed by a wall 36 to which the wall plate 10 is to be attached as illustrated in FIG. 4.

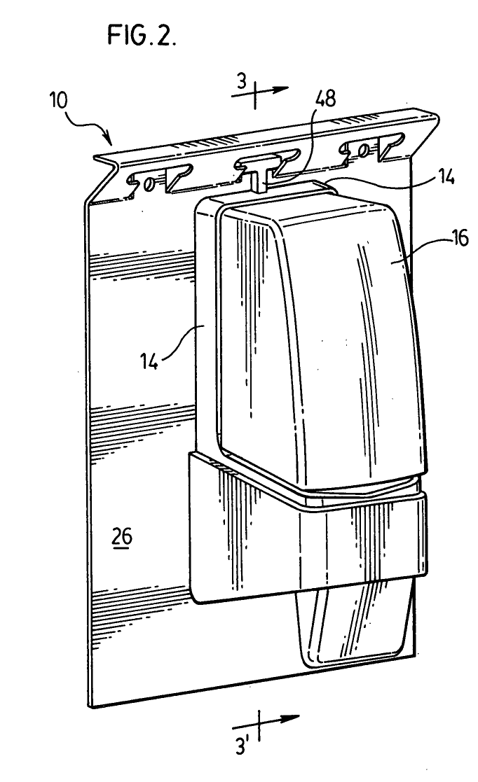

As seen in FIGS. 1 and 2, a plurality of generally T-shaped keyway openings 38 extend through the lower flange 32 into the channelway 34. The keyway openings 38 have a generally T-shaped in appearance with an enlarged width upper passage portion 39 and a reduced width lower catch portion 40.

As shown, centered on each keyway openings 38 is a securement tab 42 which is an extension of the plate portion 26 which extends upwardly from the location of the first fold line 27, is disposed in the plane of the plate portion 26 and carries a hole 43 therethrough. As seen in FIG. 4, the wall plate 10 may be secured to a wall 36 by the use of screws 44 which pass through these holes 43 in the tabs 42 and fixedly locate the wall plate 10 on the wall 36 with the rear surface 24 of the plate portion 26 flush with the surface of the wall.

The back plate 14 of the dispenser 12 carries at its upper end 45 a key member 46 generally in the shape of a “T” as seen in front view and having an enlarged width digital tab portion 47 sized to pass through the upper passage portion 39 of the keyway opening 38 however a sufficient width do not pass through the lower catch portion 40 of the keyway opening 38. The distal tab portion 47 is connected to the back plate 14 via a bridge portion 48 sized to be of a width less than the width of the lower catch portion 40 of the keyway opening 38.

To couple the dispenser 12 to the wall plate 10, the dispenser 12 is manually manipulated and positioned such that the distal tab portion 47 of the key member 46 is passed through the upper passage portion 39 of the keyway opening 38 into the channelway 34 and then moved downwardly inside the channelway 34 with the bridge portion 48 of the key member 46 extending through the lower catch portion 40 of the keyway opening 38 and the distal tab portion 47 engaging the rear surface of the lower flange 30 in the channelway 34 on either side of the lower catch portion 40 of the keyway opening 38. With the key member 46 so engaged in the keyway opening 38, the dispenser 12 may be released and will hang supported at its upper end 45 by the key member 46 being engaged in the keyway opening 38. The dispenser 12 hangs vertically downwardly with a rear surface of its back plate 14 planar with the forward surface 25 of the plate portion 26. For removal, the process is reversed and the dispenser 12 is manipulated and moved upwardly such that the distal tab portion 47 of the key member 46 is moved upwardly and then forwardly out through the upper passage portion 39 of the keyway opening 38.

In the embodiment of FIG. 1, the wall plate 10 is shown as having three separate keyway openings 38 each of which is adapted to receive a key member 46 of the dispenser. The dispenser 12 may thus be mounted in any one of the three locations. Alternatively, two dispensers may be mounted one on each of the outermost keyway openings 38. Further, a single dispenser may be provided which have two or more key members 46 spaced laterally from each other to be engaged within two of the keyway openings 38. Providing a dispenser to have at least two laterally spaced key members 46 to engage in two laterally spaced keyway openings 38 can assist in providing increased stability and resistance to side-to-side movement of the dispenser in use.

Wall plate 10 is illustrated as being a rectangular plate which has a width greater than the width of the dispenser 12 shown. It is to be appreciated that the wall plate 10 may be provided in different widths. For example, the wall plate 10 could be provided to a width as great as possible having regard to space available on a wall and to provide as many keyway openings 38 as may be desired as for mounting of multiple dispensers or other devices. Alternatively, the wall plate 10 may be sized to a width merely identical to that of a dispenser 12 to be mounted. The wall plate 10 preferably does not have any structure which extends outwardly from the wall below the securement portion 28 beyond the forward surface 25 of the plate portion 26 so that dispensers which have a vertical length greater than the length of the plate portion 26 may extend downwardly beyond the lower edge 21. The wall plate 10 may be selected to have dimensions so as to cover damaged surfaces of a wall. The wall plate 10 may preferably be formed by bending a metal sheet. Preferably, the wall plate 12 may comprise a sheet of stainless steel or a galvanized or powder-coated or otherwise painted metal so as to provide a pleasing yet sanitary decorative surface.

While a wall plate is preferably formed from a sheet of metal, it is to be appreciated this is not necessary and it may be formed from various other materials including plastic materials.

The wall plate 10 is preferably secured to the wall merely by screws or other fasteners extending through the holes 43 in the securement tabs 42 of the securement portion 28 into the wall or anchors in the wall. Various other means may be provided for securement of the wall plate to the wall. For example, screw openings (not shown) could be provided at the lower corners of the wall plate 10 through which screws could be driven through the wall plate into a wall with such screws preferably having heads which would not interfere with dispensers mounted on the wall plate. The wall plate may also be secured to the walls as by the use of nails or rivet like devices or by the use of adhesives which could be applied to the rear surface 24 of the plate portion 26. Where screws are used to pass through the holes 43 in the securement tabs 42 at the upper end of the wall plate 10, use of a small amount of adhesive along the rear surface of the wall plate proximate its lower edge 21 may be advantageous. Preferably, screws used to secure the wall plate 10 to a wall pass through the securement portion 28 whereby heads of such screws may be substantially hidden and/or located to not interfere with the dispensers.

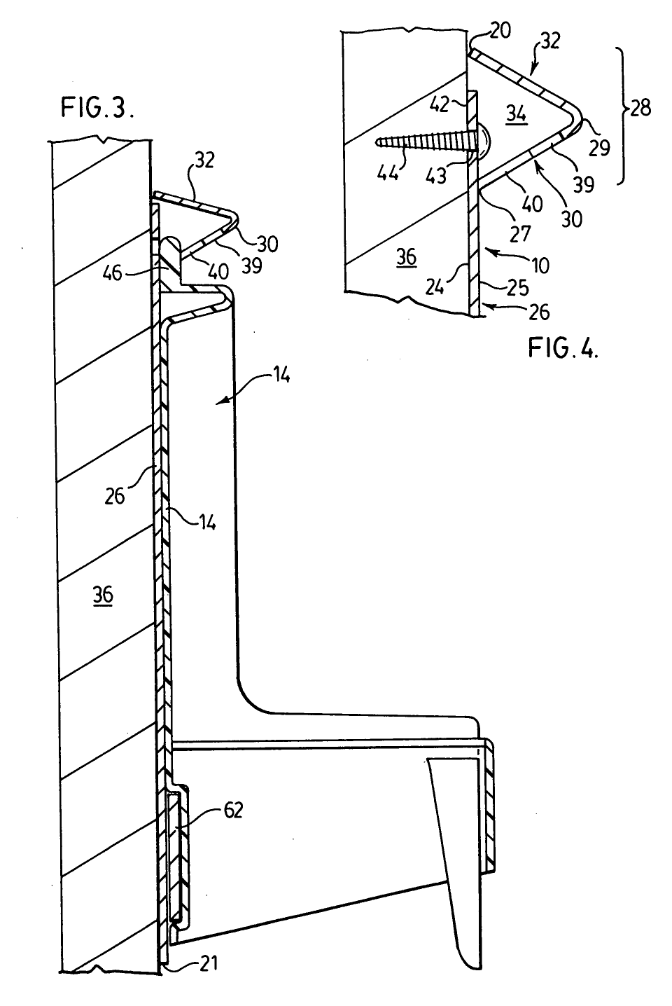

While not necessary, when the dispenser 12 is coupled to the wall plate 10 and hangs downwardly from the wall plate 10 as illustrated in FIG. 2, some mechanism may be provided to secure another portion of the dispenser to the wall plate, preferably proximate the lower end 50 of the dispenser 12. One preferred manner of accomplishing this is by the use of a permanent magnet, for example, to provide the plate portion 26 as being or having a portion which is a metal to which a permanent magnet is attracted. As seen in FIG. 3, a permanent magnet 62 may then be secured in the back plate 14 of the dispenser 12 preferably flush with the rear surface of the back plate 14 and located to overlie the metal portion of the plate portion 26 and securely engage by magnetic forces the back plate 14 proximate its lower end 21 to the plate portion 26.

Rather than use of such magnetic coupling mechanism, an adhesive may be applied to the lower rear surface of the back plate 14 to adhesively bond the back plate 14 to the forward surface 25 of the plate portion 26. Such adhesives may be selected such that for the application of forces less than forces which would cause damage to the dispenser 12 or to the wall plate 10, the adhesive bond may itself fail or fail in its adhesion to either the wall plate 10 or to the dispenser 12. The adhesive preferably would be provided such that it may be readily removed at least from the wall plate 10 as by mechanical scraping or chemical dissolution. It is not necessary however that the dispenser 12 be secured other than by hanging from its key member 46.

Rather than use of magnetic coupling devices, suction cups could be secured on the rear of the back plate 14 of the dispenser 12 for secure removable coupling with the plate portion 26.

While screws could be provided to pass through the back plate 14 of the dispenser and through the plate portion 26, this is generally not desired as it would leave holes through the plate portion 26.

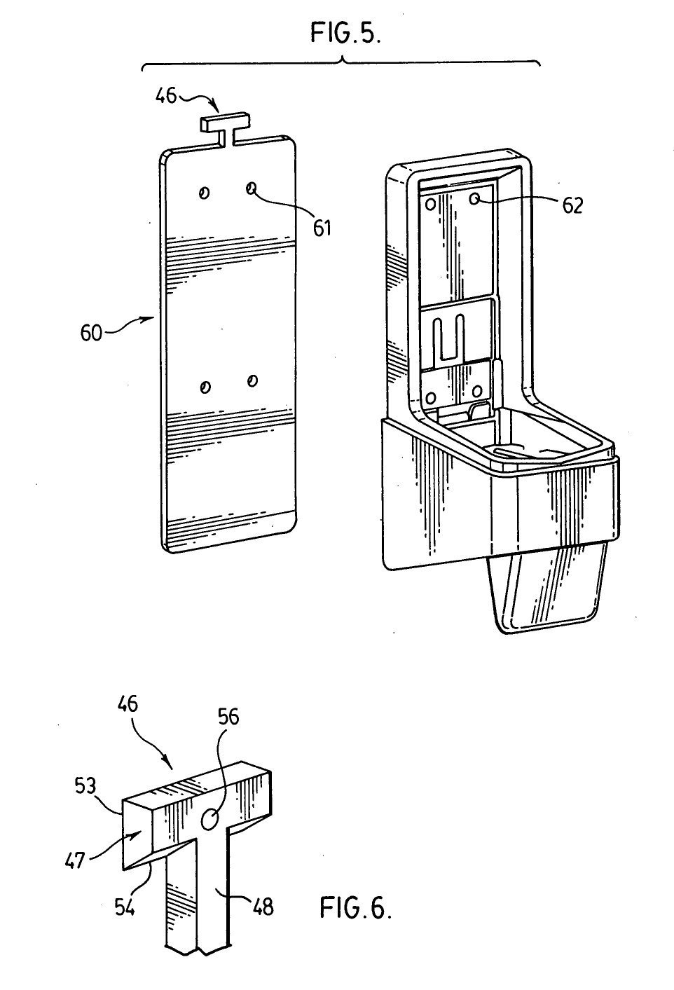

In the preferred embodiment shown in FIG. 1, the back plate 14 of the dispenser 12 and the key member 46 are formed as an integral member as by injection moulding from plastic. This is not necessary and the key member 46 may be provided as a separate element as for a securement to an existing back plate of the dispenser. In this regard, reference is made to FIG. 5 showing an adaptor plate 60 for securing to a back plate 14 for a dispenser which does not have the key member 46. Rather, the adaptor plate 60 carries the key member 46. The adaptor plate 60 may be secured to the rear of the back plate 14 as by screws, rivets and the like through complementary holes 61 and 62, or by mechanical interaction of features or outwardly extending flanges or plates and the like of the sheet metal plate with complementary structure on the back plate, preferably such that the securing mechanism does not extend rearwardly beyond a planar rear surface of the adaptor plate 60. The adaptor plate 60 can be fashion as by stamping from a planar sheet of material which may comprise, for example, merely a sheet of metal or a laminate comprising a sheet of metal covered on its rear by a layer of material which is a permanent magnetic attractive to the wall plate 10, such layers of magnetic material may comprise a flat relatively thin (about 1/16 to 1 inch) magnetized iron or steel sheet material or of a rigid or flexible non-magnetic synthetic resinous plastic such as polystyrene, polypropylene, acrylic, or the like, having finely divided magnetic particles distributed throughout the body.

Typically, back plates are adapted for mounting to a wall as by passing screws through openings therein. Such openings may be used, for example, for connection to an adaptor member 60 carrying the key member 46. Preferably, the arrangement of the key member when secured as a separate element to the back plate of the dispenser will be arranged so as to minimize any spacing of the rear surface of the back plate of the dispenser from the front surface of the wall portion.

The keyway openings 38 on the securement portion 28 provide in effect an engagement element on the securement portion 28. The key member 46 on the dispenser 12 effectively comprises an engagement member on the dispenser which is adapted to engage the engagement element on the securement portion 28 to removably secure the dispenser 12 to the wall plate 10. It is to be appreciated that these elements could be reversed as, for example, with a key member provided on the securement portion 28 and the keyway openings 38 provided in the upper end of the back plate 14 of the dispenser.

The particular nature of the engagement element and complementary engagement member to be provided on the dispenser or wall plate or vice versa is not limited. Various hooks, catches, ball-in-socket, dovetail, wedging and other catch type complementary engagement arrangements may be used.

In the preferred embodiment, from the position illustrated in FIG. 2, the dispenser 12 may be pivoted about a laterally extending axis through the distal tab portion 47 so as to move a lower portion of the dispenser 12 forwardly away from the plate portion 26. The configuration of the distal tab portion 47 may be selected such that it may only pass through the upper passage portion 39 of the keyway openings 38 when the dispenser 12 is pivoted to be in a position at a selected angle to the vertical that is, for example, at 45° or 90° and that once the distal tab portion 47 is inserted in this desired angle orientation through the upper passage portion 39, on rotation of the dispenser 12 downwardly, the distal tab portion 47 assumes angular orientations in which its vertical height is greater than the vertical height of the upper passage portion 39. It is to be appreciated that this can be accomplished by having the distal tab portion 47 sized to have a rectangular shape as schematically shown in the embodiment of FIGS. 6 to 8 with such rectangular shape only being permitted to pass through the upper passage portion 39 when the rectangular shape is disposed such that its side surfaces 52 are normal to the surface of the lower flange 30, as seen in FIG. 8.

In the embodiment shown in FIGS. 6 to 8, the distal tab portion 47 has a flat rear surface 53 and to have a bottom surface 54 which is disposed to extend forwardly and upwardly at an angle substantially identical to the angle of the rear surface of the lower flange 30. On the distal tab portion 47 being placed inside the channelway 34 and being drawn vertically downwardly by the weight of the dispenser 12, the rear surface 53 of the distal tab portion 47 engages vertical forward surface of the securement tab 42 and the bottom surface 54 of the distal tab portion 47 engages the rear surface of the lower flange 30 thus tending to locate and secure the distal tab portion 47 against rotation so as to locate the dispenser 12 with its rear surface vertical and in close engagement with the forward surface 25 of the plate portion 26. Other arrangements for engagement between the engagement element and the engagement member may cause or bias the dispenser 12 to hang with its rear flush with the plate portion 26.

The key member 46 need not be of a T-shaped as shown but may have many other shapes including a distal tab portion which is ball shaped, of a generally dovetail shape and various other shapes which can be complementary for engagement between an engagement element on the securement portion and an engagement member on the dispenser.

Preferably, the engagement element on the securement portion may be provided on the generally downwardly directed lower flange 30 so as to improve the appearance when the wall plate is secured to a wall and often is seen from above. Various other forms of securement portions including these having channel members may be secured to the top of the plate portion and may be, for example, bent into different shapes. The securement portion may comprise a plastic or metal member formed as by extrusion and from which the engagement element or engagement member be cut out or attached.

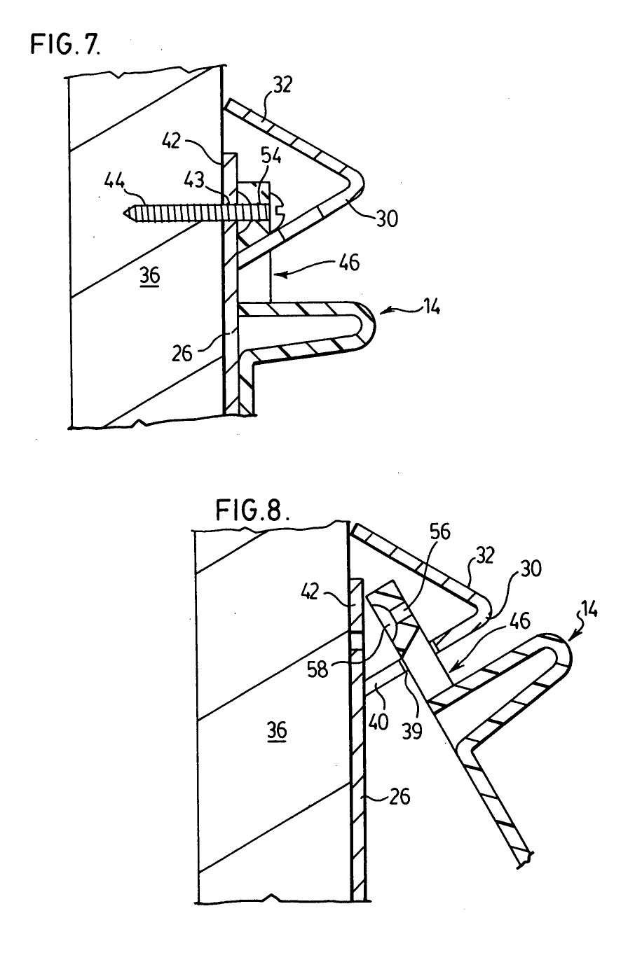

The preferred embodiment shows screws 44 extending through the holes 43 in the securement tab 42 to secure the wall plate 10 to the wall. The embodiment illustrated in FIGS. 6 to 8 is provided with an opening 56 through the key member 46 which opening is adapted to align with a hole 43 through the securement tab 42. This opening 56 may have an enlarged rear portion 58 so as to fit over a head of a screw received on the securement tab 42. Alternatively, a screw through the securement tab 42 may be removed and after the dispenser has been engaged with the securement portion, the same or a longer screw 44 may be passed through the opening 56 in the key member 46, through the hole 43 in the securement tab 42 and into the wall 36 as seen in FIG. 7 to assist in rigidly securing the back plate 14 on top of the wall plate 10 against movement or removal.

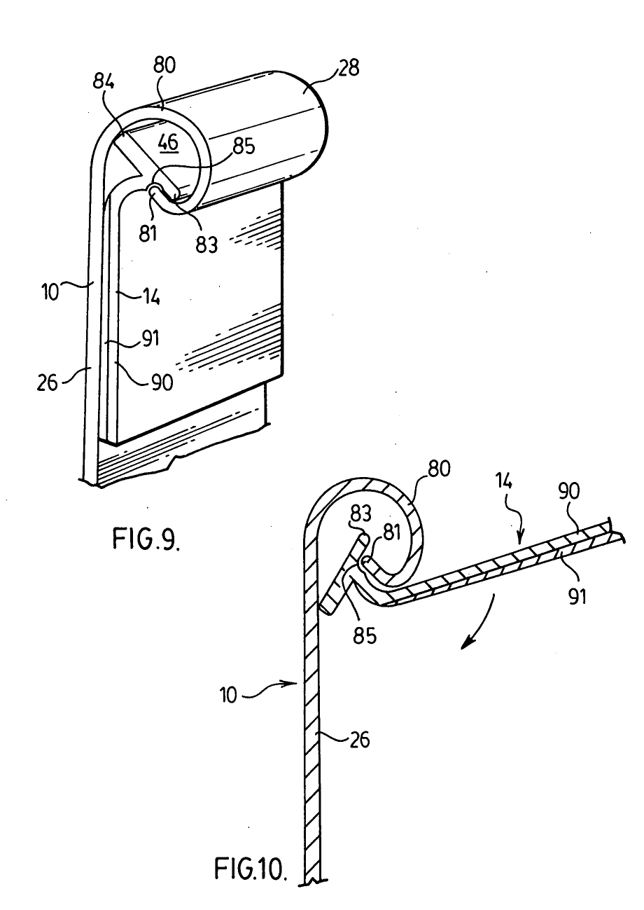

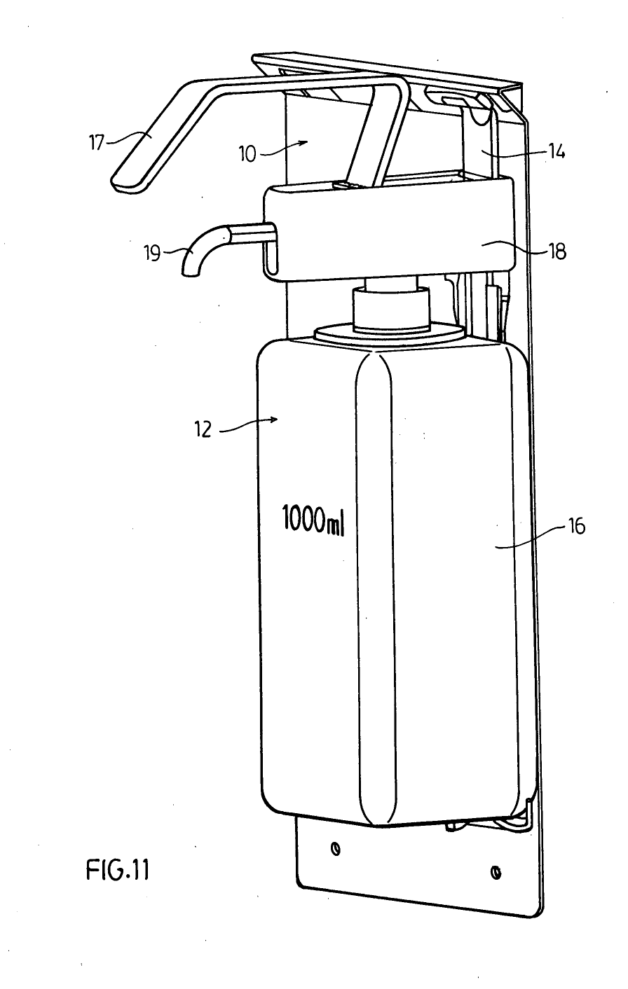

Reference is made to FIGS. 9 and 10 showing schematically a fourth embodiment of a wall plate 10 with a securement portion 28 formed as a resilient, curved member 80 with an upwardly and rearwardly directed distal end 81. The back plate 14 carries as a key member 46 a wedge member having a first end 83, a second end 84 and a pivot recess 85. The key member 46 may be positioned as seen in side view in FIG. 10 with the first end 83 inside the curved member 80 and the distal end 81 in the pivot recess 85, and from this position pivoted clockwise to urge the distal end 81 outwardly so that the key member 46 may come to assume the engaged position seen in FIG. 9 to which it is biased by the resiliency of the curved member 80. FIGS. 9 and 10 also show the back plate 14 as having a planar portion formed as a laminate with a front layer 90 of metal and a rear layer 91 of a permanent magnet which will adhere to the front surface of the plate portion 26.

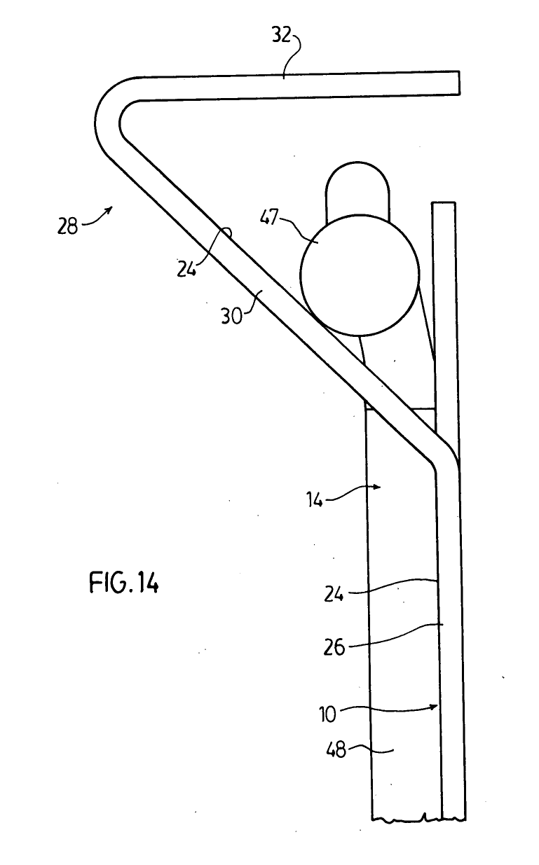

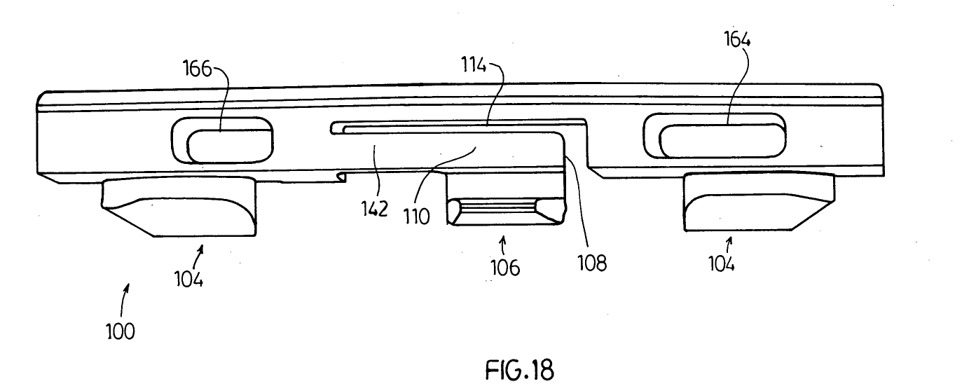

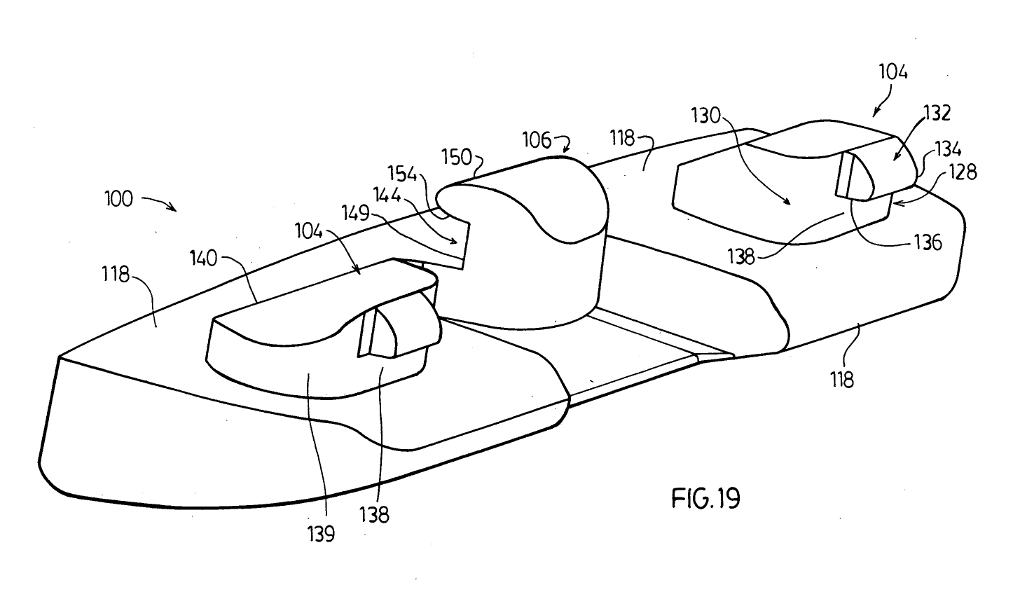

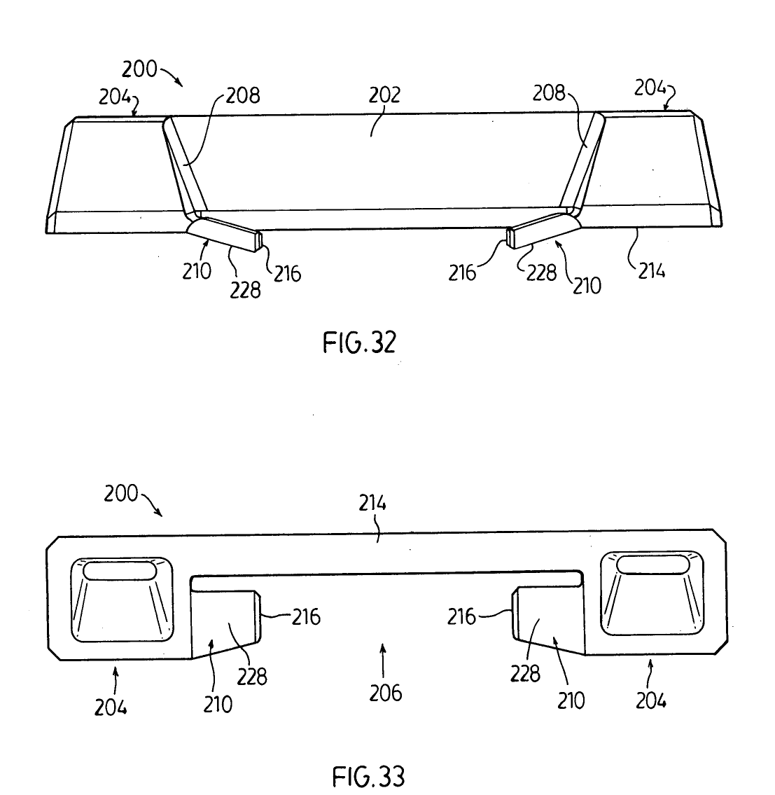

Reference is made to FIGS. 11 to 36 which illustrate a fifth embodiment of a wall plate system in accordance with the present invention. The wall plate 10 shown in FIG. 11 is effectively identical to the wall plate shown in FIGS. 1 to 4, however, with the difference that in the fifth embodiment as seen in FIGS. 11, 12, 14 and 15, the lower flange 30 and the upper flange 32 are disposed at different relative angles to the plate portion 26 than in the case of the first embodiment of FIGS. 1 to 4. As best seen, for example, in the side view in FIG. 14, the upper flange 32 is disposed to be substantially horizontal, that is, effectively normal to the plate portion 26. In the fifth embodiment, a differently configured dispenser 12 is removably coupled to the wall plate 10. The dispenser 12 similarly comprises a back plate 14, a replaceable fluid reservoir 16 and a pump 18 which can be operated by a manual handle 17 to dispense fluid from a nozzle 19.

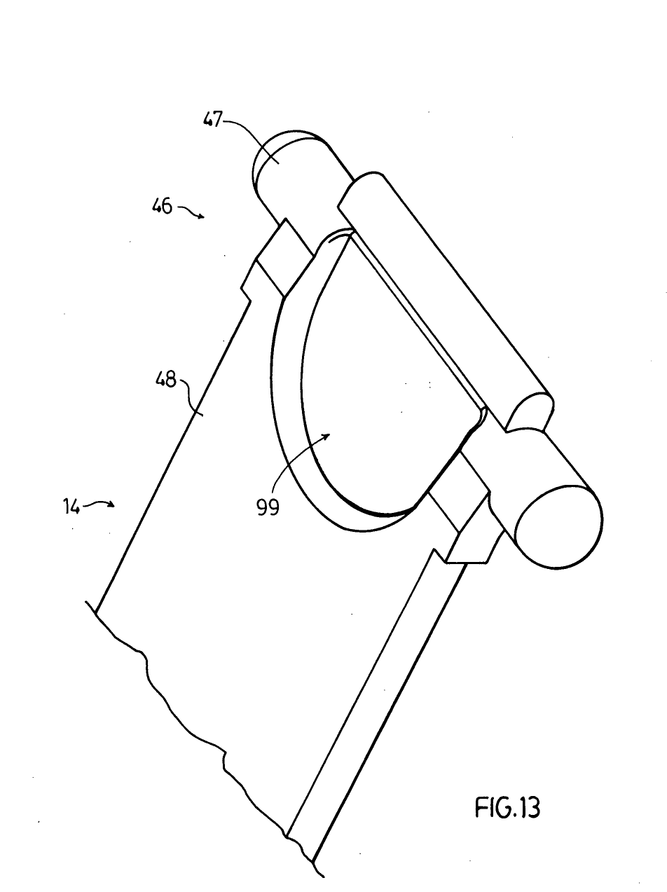

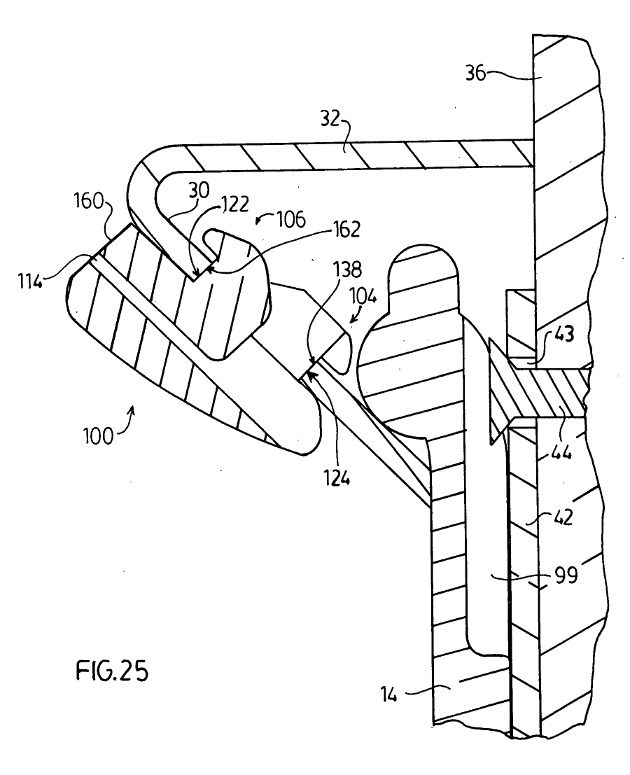

FIG. 13 shows a rear perspective view of the upper end of the back plate 14 showing the T-shaped key member 46 as including a tab portion 47 shown to be cylindrical about a generally horizontal axis when the dispenser 10 is suspended as shown in FIG. 11 with the tab portion 47 extending to the side beyond the bridge portion 48. A central recess 99 is provided in the rear of the key member 46, for example, to avoid interference with the head of a screw 44 which, as seen in FIG. 25, may pass through the hole 43 in the securement tab 42 which underlies the key member 46.

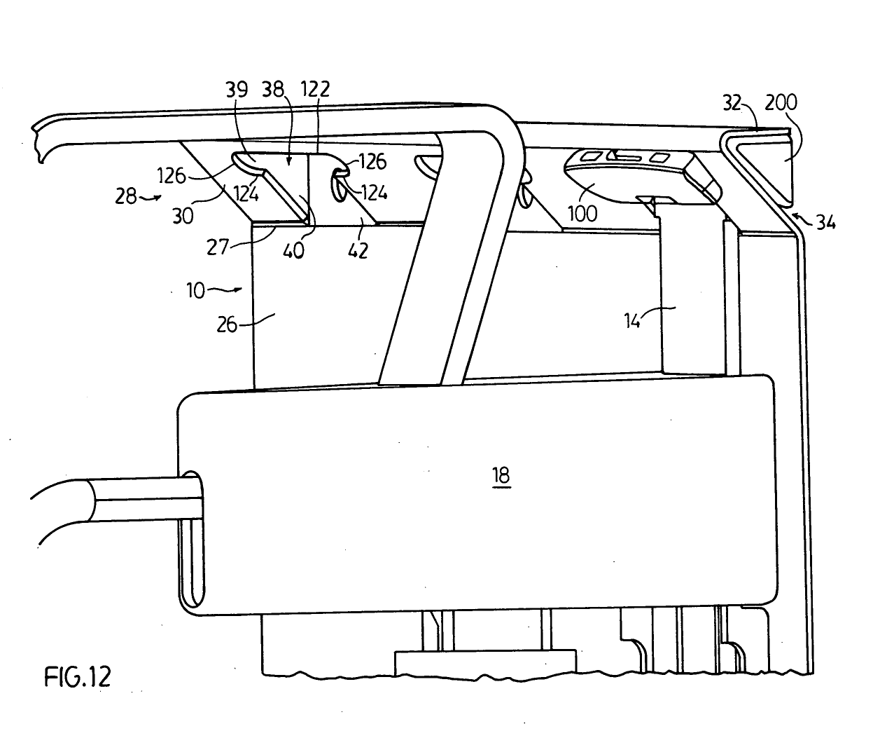

Referring to FIG. 14, as seen in side view, the cylindrical tab portion 47 is carried forwardly from a planar rear surface 24 of the plate portion 26 of the wall plate 10 such that there is engagement between the cylindrical tab portion 47 and the rear surface 24 of the lower flange 30 tending to urge the rear surface of the back plate 14 into the forward surface 24 of the plate portion 26 of the wall plate 10. As with the first embodiment, in the fifth embodiment illustrated in FIG. 12, the lower flange 30 of the securement portion 28 of the wall plate 10 has T-shaped keyway openings 38 with an enlarged width upper passage portion 39 and a reduced width lower catch portion 40. The key member 46 carried on the back plate 14 has its circular tab portion 46 sized to pass through the upper passage portion 39 of the keyway opening 38, however, of a sufficient width to not pass through the lower catch portion 40 of the keyway opening 38. The bridge portion 48 is similarly sized to be a width less than the width of the lower catch portion 40 of the keyway opening 38.

Reference is made to FIG. 12 which shows firstly a lock member 100 secured to the wall plate 10 to prevent removal of the back plate 14. FIG. 12 secondly shows a plug member 200 engaged in the end of the channelway 34 of the securement portion 28.

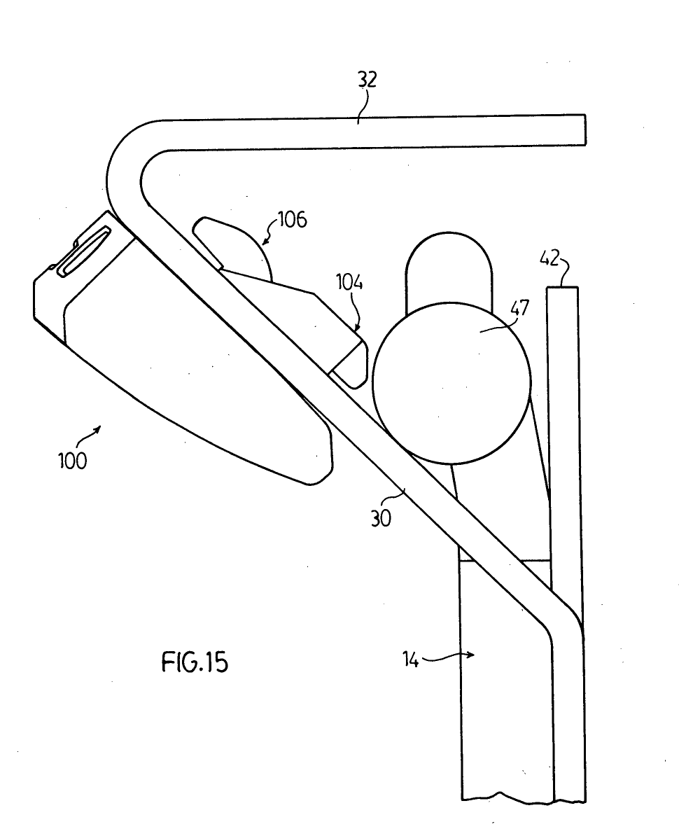

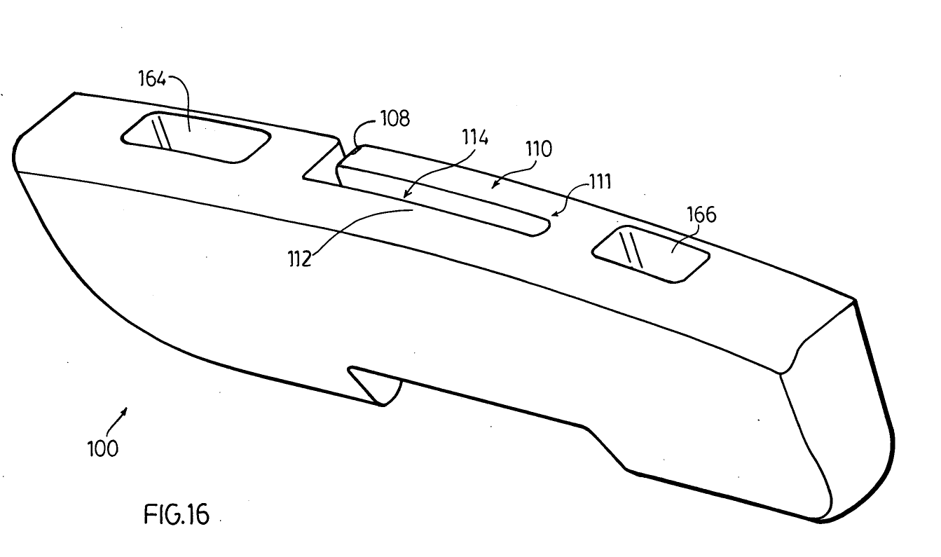

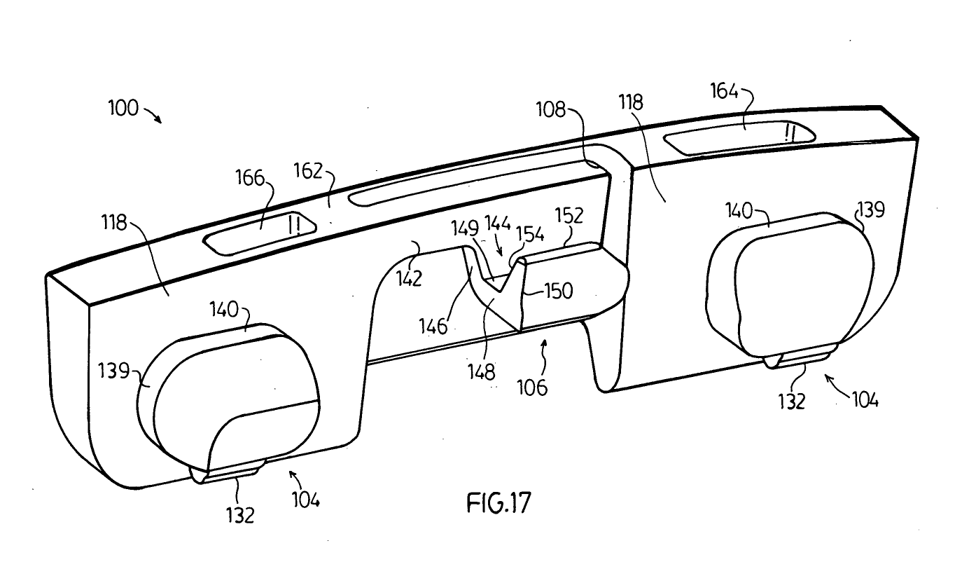

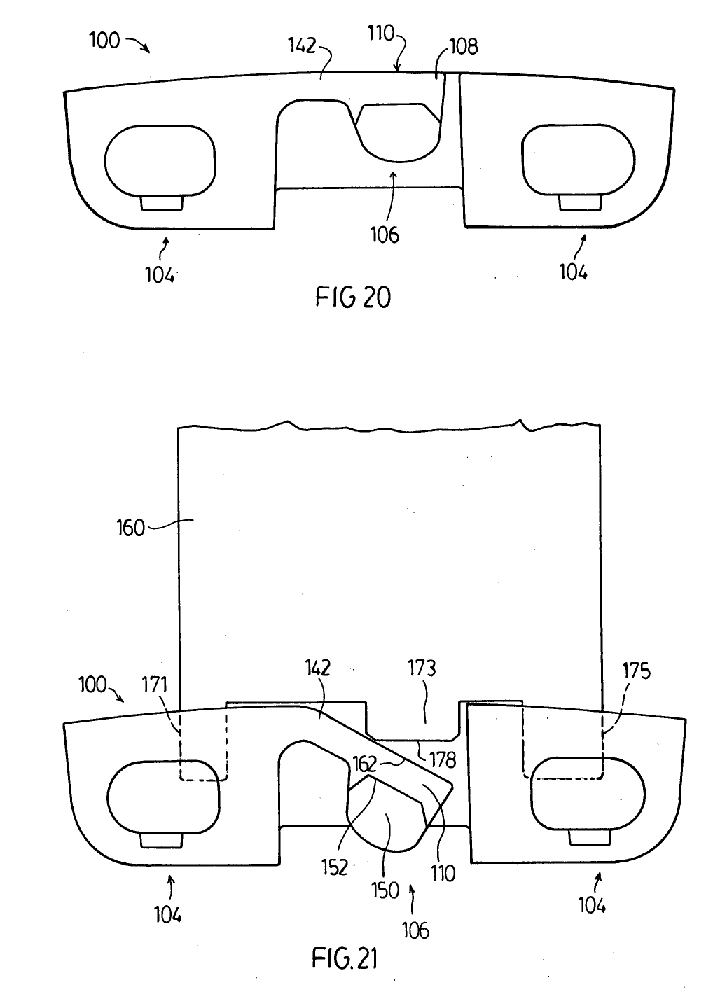

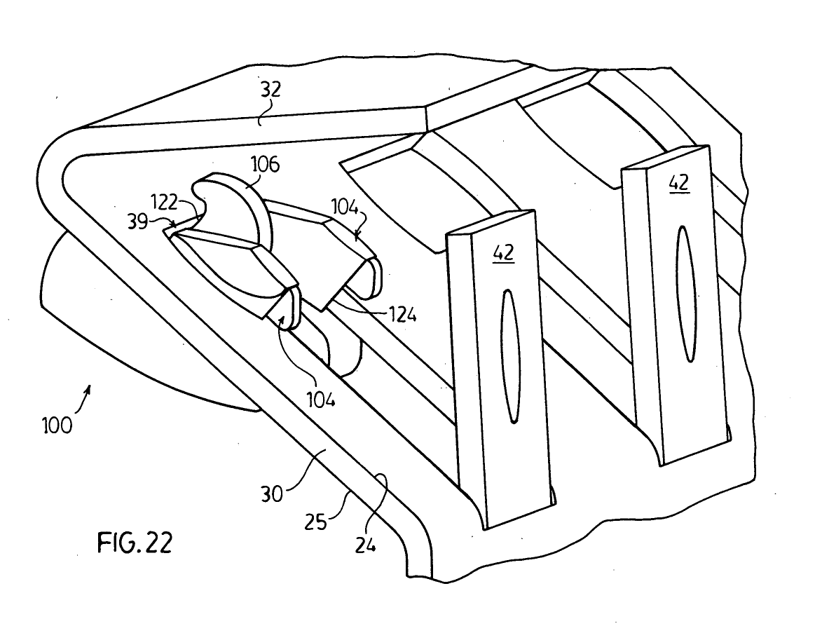

Reference is made to FIGS. 15 to 26 which more particularly describe the lock member 100. The lock member 100 comprises a generally elongate body which carries on its rear two downwardly directed lower catch hooks 104 and an upwardly directed upper catch hook 106. The upper catch hook 106 is carried on the distal end 108 of a resilient catch arm 110 joined as at 111 to the body. The catch arm 110 extends longitudinally of the lock member body and is spaced from a central bridging portion 112 by a generally vertically extending slot 114. As best seen in FIG. 21, by the application of downwardly directed forces as indicated by the arrow 116 in FIG. 21, the catch arm 110 may be moved from the extended rest position shown in FIG. 20 to the withdrawn position shown in FIG. 21. The lock member 100 is preferably formed as an integral member from resilient material with the catch arm 110 having an inherent bias to assume the rest position shown in FIG. 20 and to bias the catch arm 110 to assume this rest position if deflected to the withdrawn position shown in FIG. 21 and released. As best seen in the rear views of FIGS. 17, 19 and 20, the lock member 100 has a rear surface 118 whose margins extend a greater extent than the upper passage portion 39 of the lower flange 30 of the wall plate 10 such that as seen in FIG. 22 when the lock member 100 is secured to the wall plate 10, the rear surface extends beyond the edges of the upper passage portion 39. With the lock member 100 being secured over the upper passage portion 39, the lock member 100 blocks the key member 46 within the channelway 34 of the securement portion 28 against removal.

Referring to FIG. 12, the upper passage portion 39 includes an upper end 122 to which two shoulders 124 on a lower end are opposed. Each of the shoulders 124 is provided adjacent where the reduced width lower catch portion 40 extends downwardly from the upper passage portion 39. The upper passage portion 39 has two sides 126 joining the shoulders 124 and the end 122. Referring to FIG. 22, the lock member 100 is engaged to the lower flange 30 with the lower catch hooks 104 engaging a respective shoulder 124 on either side of the upper passage portion 39 and the upper catch hook 109 engaging the upper end 122 of the upper passage portion 39 intermediate its length.

Referring to FIGS. 17 to 19, each of the lower catch hooks 104 extend rearwardly from the rear surface 118 and present a downwardly opening U-shaped slotway 128 defined between the rear surface 118, a locating member 130 and a downwardly extending hook arm 132 which extends to a distal end 134 and presents a forward surface 136. The slotway 128 is sized having regard to the thickness of the lower flange 30 between its rear surface 24 and forward surface 25 such that the shoulder 124 of the lower flange 30 will be securely received within the slotway 128. The bight-like locating member 130 presents a downwardly facing end surface 138 to engage the shoulder 124. Side surfaces of the locating member 130 include the bight surface 138, a curved surface 139 and a flat upper surface 140 which correspond in shape and are marginally smaller than the opening defined by the shoulder 124, side 126 and end 122 of the upper passage portion 39 such that the two locating members 130 locate the lock member 100 relative the upper passage portion 39 against substantial side-to-side or up and down movement in the plane of the lower flange 30.

As seen in FIGS. 17, 18 and 19, the catch arm 110 has a resilient bridge portion 142 joining the upper catch hook 106 to the remainder of the lock member 100. The catch arm 110 increases in vertical height as it extends from the bridge portion 142 to its distal end 108. The upper catch hook 106 has an upwardly directed slotway 144 between a forward lower arm portion 146 of the catch arm 110, a bight portion 148 and an inner arm portion 150. The inner arm portion 150 extends upwardly to a distal end 152 and presents a forwardly directed inner surface 154. The slotway 144 is selected having regard to the thickness of the lower flange 30 between its rear surface 24 and forward surface 25 that the upper end 122 of the upper passage portion 39 is securely received within the slotway 144. The vertical distance between the downwardly directed bight surface 138 on the lower catch hooks 104 and an upwardly directed bight surface 149 of the bight portion 148 of the upper catch hook 106 is proximate the vertical distance between the end 122 and the shoulder 124 of the upper passage portion 39. Preferably, the vertical distance from the bight surface 138 of the lower catch hooks 104 and the bight surface 149 of the upper catch hook 106 is less than the vertical distance between the end 122 and each shoulder 124 of the upper passage portion 39 such that the resilient catch arm 110 will marginally be deflected from its unbiased condition thus holding the lock member 100 compressed within the passage portion 39 between the end 122 and the shoulders 124. In this regard, in FIG. 21, the profile of the T-shaped keyway opening 138 of the lower flange 30 is shown in dotted lines.

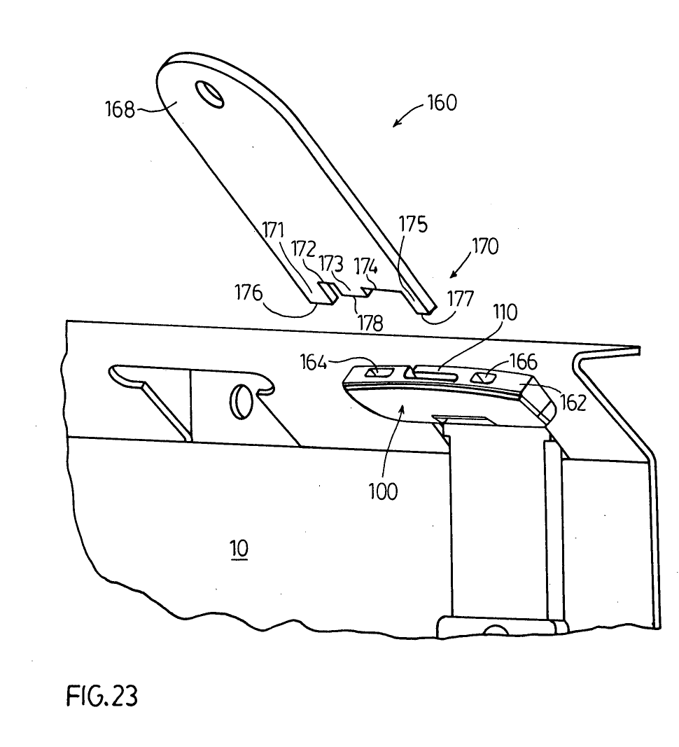

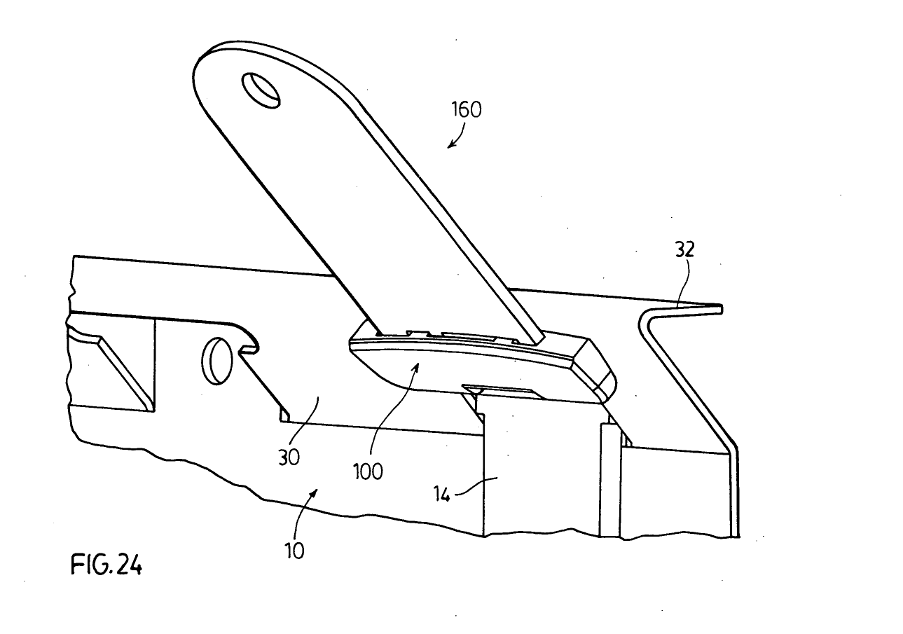

Reference is made to FIGS. 23 and 24 which illustrate a tool 160 for use to assist in engagement and disengagement of the lock member 100 with the wall plate 10. The lock member 100 has an upper surface 162. A large guide slot 164 extends downwardly from the upper surface 162 into the lock member 100. A similar small guide slot 166 extends downwardly from the upper surface 162 into the lock member 100. Each of the guide slots 164 and 166 are shown to be rectangular having a similar front to back width, however, they differ in their lateral extent. Each preferably extends vertically downwardly into the lock member 100 parallel to each other to respective blind ends.

The lever tool 160 as best seen in FIG. 23 is formed from a flat sheet of material, preferably metal, having a constant thickness, a first manipulation end 168 to be held manually by a user and a second engagement end 170 to engage the lock member 100. The engagement end 170 is provided with three downwardly extending prongs, namely a large guide prong 171, a cam prong 173 and a small guide prong 175. The large guide prong 171 corresponds in shape to the large guide slot 164 and is adapted for vertical sliding therein. Similarly, the small guide prong 175 has a shape corresponding with the small guide slot 166 and is vertically slidable therein. Between the large guide prong 171 and the cam prong 173 an end stop surface 172 extends normal to the prongs. Similarly, between the cam prong 173 and the smaller guide prong 175 an end stop surface 174 extends. In the preferred embodiment, the end stop surfaces 172 and 174 are spaced a constant distance from, and are parallel to, the end 176 of the prong 171 and the end 177 of the prong 175. The prongs 171 and 175 extend a greater distance from the end stop surfaces 172 and 174 than the cam prong 173 such that the end surface 178 of the cam prong 173 is recessed upwardly from the ends 176 and 177.

In use, the large prong 171 is inserted into the large guide slot 164 concurrently with the small guide prong 175 being inserted into the small guide slot 166 and are slid inwardly into the respective guide slots 164, 166 until the end surface 178 of the cam prong 173 engages the upper surface 162 of the catch arm 110 proximate the distal end 108 of the catch arm 110. With further relative downward movement of the tool 160 relative to the lock member 100, with the guide prongs 171 and 173 guided within the guide slots 164 and 166, the cam prong 173 deflects the cam arm 110 from its unbiased rest position shown, for example, in FIGS. 20, 23 and 25 toward the withdrawn position illustrated in FIGS. 21 and 26. As seen in FIG. 21, engagement between the end stop surfaces 172 and 174 of the tool 160 limits deflection of the catch arm 110. With the upper catch hook 106 in the withdrawn position as seen in FIG. 26, the distal end 152 of the inner arm portion 150 of the lower catch hook 104 is below the upper end 122 of the upper passageway portion 39 and the hook member 100 may be pivoted about a fulcrum formed between the shoulders 124 of the upper passage portion 39 and the bight surface 138 of the lower catch hooks 104 counterclockwise from the position of FIG. 26 to a position in which the upper catch hook 106 is forward and underneath the lower flange 30 and the lock member 100 can then be removed from the lower flange 30 by subsequent sliding forwardly and upwardly to withdraw the lower catch hooks 104 from the upper passage portion 39.

The tool 160 in use provides not only for compression of catch arm 110 to move the upper catch hook 106 to the withdrawn position but also provides a lever to pivot the lock member 100 about the fulcrum between the shoulders 124 and bight surfaces 138 into and out of the upper passage portion 39 when the upper catch hook 106 is in the withdrawn position. Coupling of the lock member 100 with the tool 160 is a reversal of the removal process with the lower catch hooks 104 engaged on the shoulders 104, the tool 160 compressing the upper catch hook 106 to the withdrawn position and the tool 160 pivoting the lock member 100 clockwise about the fulcrum.

In use, a dispenser 12 is coupled to the wall plate 10 with its back plate 14 having a key member 46 received within the channelway 34 as, for example, illustrated in FIG. 14 and passing through the lower width catch portion 40. Subsequently, the locking member 100 is coupled in the keyway opening 38 to assume the locked, engaged position shown in FIG. 25 in which position the locking member 100 prevents disengagement of the back plate 14 from the wall plate 10 by preventing removal of the key member 46 from the key opening 38.

The relatively small size of the upper surface 162 of the catch arm 110 which needs to be engaged and depressed downwardly for removal of the lock member 100 assists in preventing unwanted removal and assists in preventing removal without the use of the tool 160. Additionally, the need to maintain the catch arm 110 depressed downwardly at the same time as pivoting the lock member downwardly for removal assists in preventing unwanted removal and tampering. Since the lock member 100 is disposed on the lower flange 30 underneath the upper flange 32, access to the lock member 100 is restricted by reason of the close proximity of other portions of the dispenser 12 notably the rear portions of the handle 17 as seen in FIG. 11.

The lock member 100 is preferably manufactured by injection moulding from plastic as a unitary element providing the catch arm 110 and notably its bridging portion 142 to have an inherent resiliency.

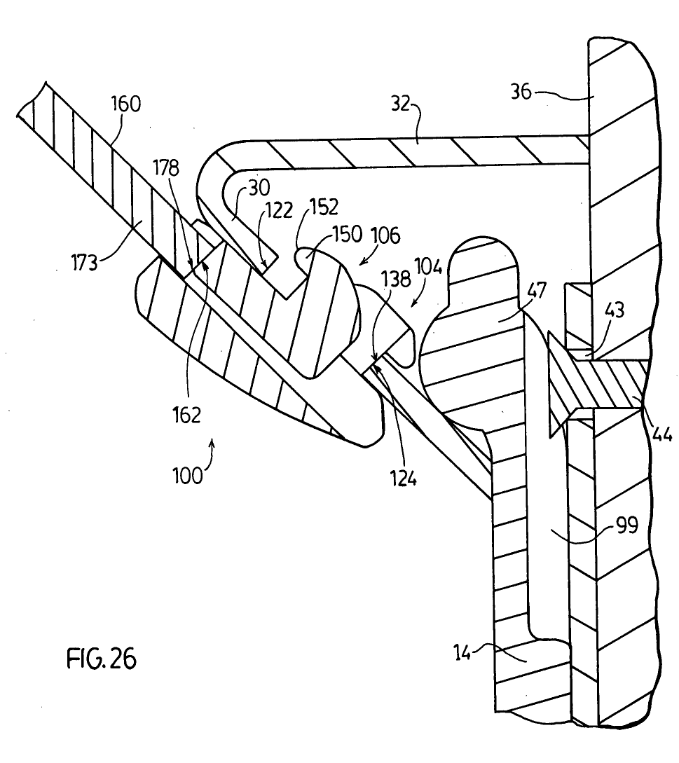

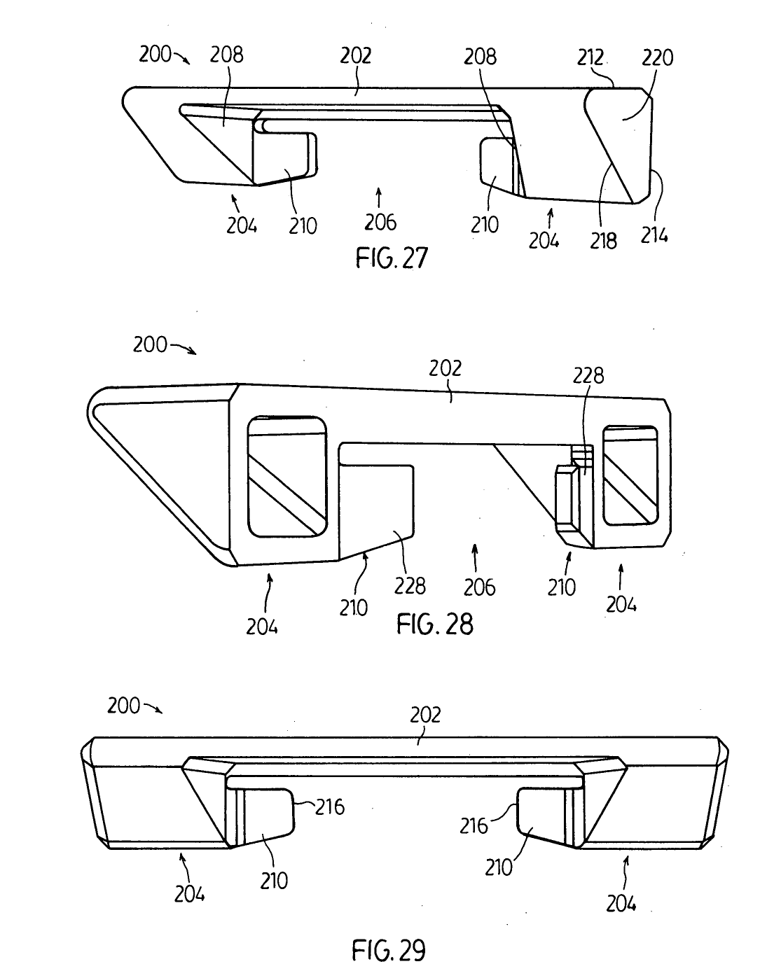

Reference is made to FIGS. 27 to 36 which further describe the plug member 200 adapted to be received within the channelway 34 of the securement portion 28 of the wall plate 10. The plug member 200 may serve a number of purposes. Firstly, it provides a decorative closure to an end of the channelway 34. Providing such a closure to the channelway 34 prevents attempted access to a lock member 100 longitudinally through the channelway 34. As a closure to the channelway 34, the plug member also prevents the passage of a rope longitudinally through the channelway 34 so as to prevent the channelway as being used as a location for securing of rope upon which a distressed person might attempt to hang himself. In accordance with the preferred embodiment of the plug member 200 illustrated, the plug member 200 engages the securement tab 42 of the wall plate 10 to prevent removal of the plug member 200 once the wall plate 10 is secured to a wall. The plug member 200 is preferably to be applied to the wall plate 10 prior to engagement of the key member 46 of a dispenser 12 within the keyway opening 38. The plug member 200 once applied to the wall plate 10 does not interfere with the insertion or removal of either the key member 46 or the lock member 100.

As seen in FIG. 27, the plug member 200 is generally U-shaped having a central bridge portion 202 and two end portions 204 which extend downwardly from bridge portion 202 at each end of the bridge portion defining a channelway 206 below the bridge portion 202 and in between the interior end walls 208 of each of the end portions 204. From a rear edge of each end wall 108 of each end wall portion 204, a catch arm 210 extends inwardly towards the other end wall portion 204 and marginally rearwardly

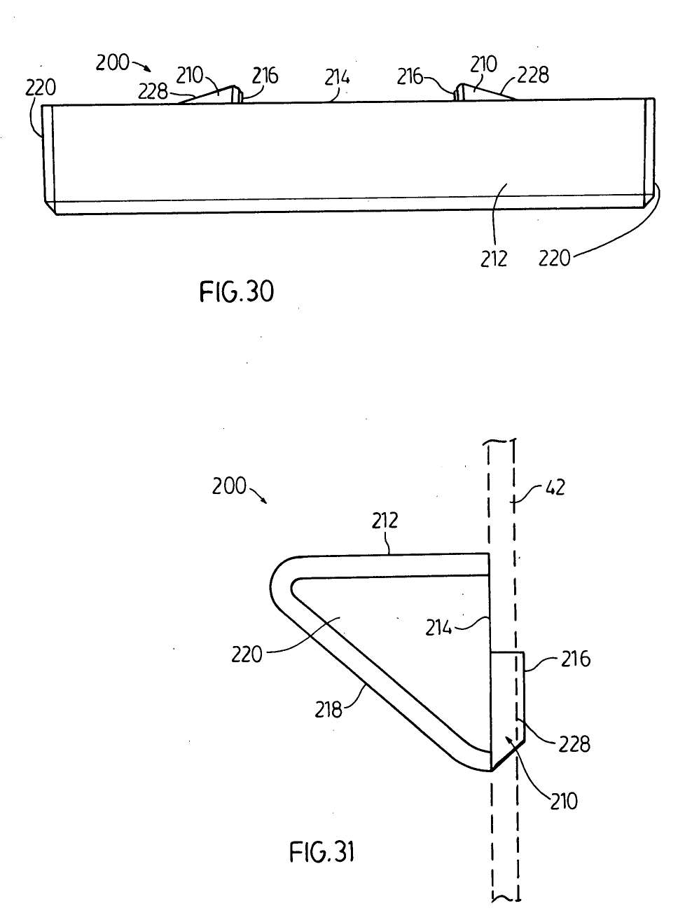

The plug member 200 is shown as having a generally horizontally disposed top surface 212 and a generally vertically disposed rear surface 214. As may be best seen in FIG. 30, the catch arms 210 extend from the inner rear of each interior end wall 208 of each end portion 204 inwardly and rearwardly to a respective distal end 216. The distal ends 216 are spaced a distance equal to the side-to-side width of the securement tab 42 of the wall plate 10. FIG. 31 shows in dashed lines, seen in a vertical view, the securement tab 42 behind the unbiased catch arms 210 as not extending rearwardly as far as the catch arms 210.

Each of the plug portions 200 includes a front surface 218 and an outer end wall 220.

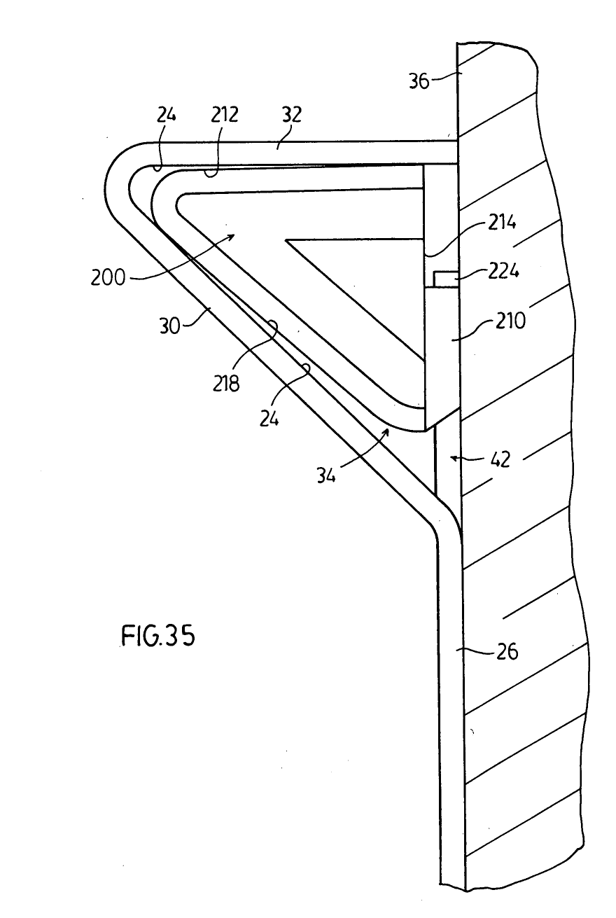

As seen in side view in FIG. 35, the plug member has a generally triangular profile such that it is adapted to fit with its top surface 212 closely mirroring the rear surface 24 of the upper flange 32; its rear surface 214 engaging the front surface 24 of the securement tab 42 and the front surface 218 closely mirroring the rear surface 24 of the lower flange 30. As seen in FIG. 31, the catch arms 210, when unbiased, extend rearwardly from the rear surface 214 a distance greater than the width of the securement tab 42 between its rear surface 24 and the front surface 25 such that the distal ends 116 of the catch arms 210 will, as seen in FIG. 35, engage the wall 36 to which the wall plate 10 is attached and the catch arms 210 are compressed to urge the plug member 200 forwardly away from the wall place the top surface 212 and front surface 218 into a forwardly wedged position within the wedge-shaped channelway 34 bounded by the upper flange 32 and the lower flange 30.

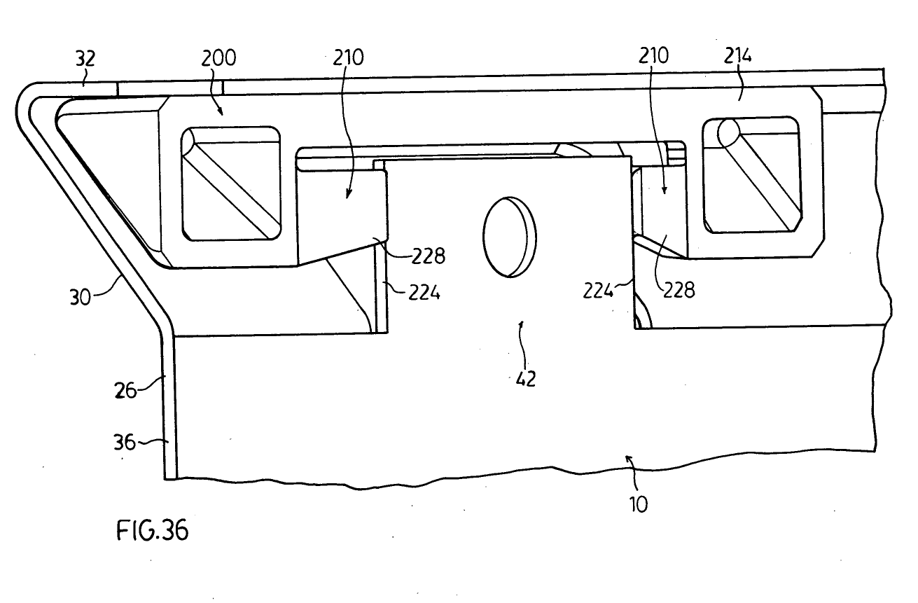

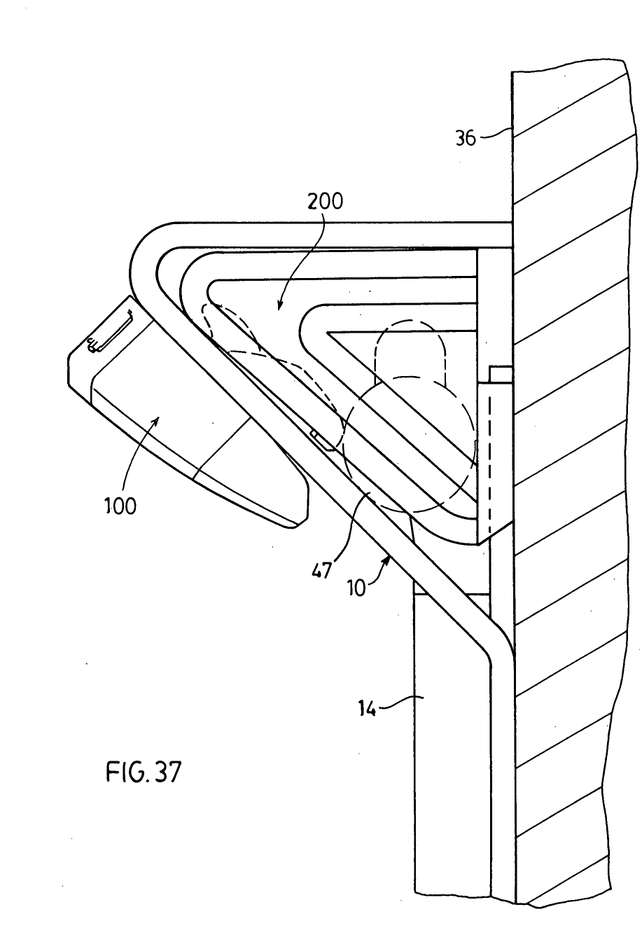

The plug member 200 when coupled to the wall plate 10 receives the securement tab 42 of the wall plate 10 between its catch arms 210 in a manner that prevents removal of the plug member 200 when the wall plate 10 is secured to the wall 36. As seen, for example, in the schematic rear view in FIG. 36, when secured in place, the engagement of the catch arms 210 on the side edges 224 of the securement tab 42 prevents longitudinal sliding of the plug member 200 within the channelway 34. Further, as seen in FIG. 35, with the wall plate 10 secured to the wall 36, there is no room within the channelway 34 for the plug member 200 to be moved forwardly such that the catch arms 210 may be moved forward sufficiently to clear the side edges 224 of the securement tab 42.

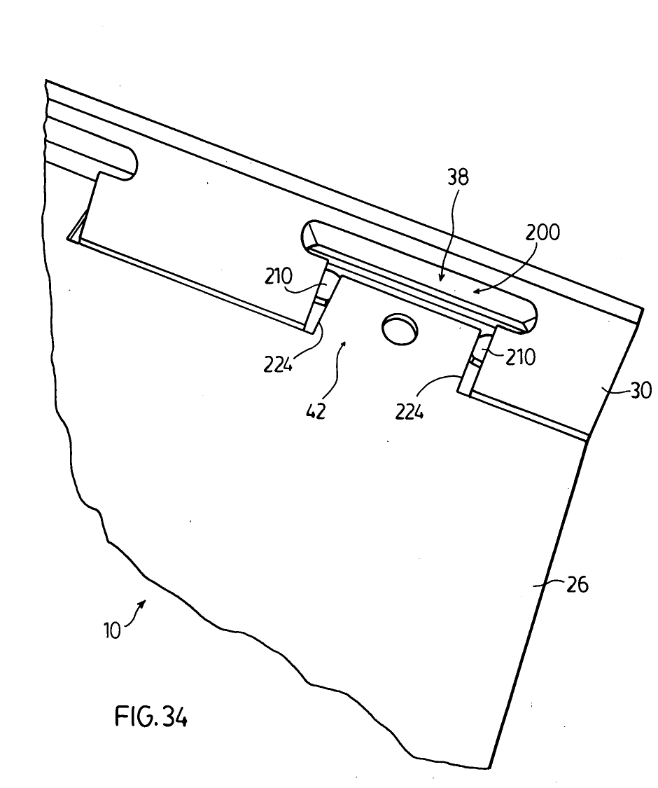

The plug member 200 may be secured to the wall plate 10, prior to securing the wall plate 10 to the wall, by locating the plug member 200 in the channelway 34 with the securement tab 42 between the catch arms 10 and then securing the wall plate to the wall as by passing screws 44 through the holes 43 in the wall plate 10. Alternatively, after a wall plate 10 has been secured to the wall, the plug member 200 may be slid longitudinally into an open end of the channelway 34. On sliding an end of the plug member 200 into the channelway 34, the rear surface 228 of the catch arm 210 on the end of the plug member 200 being slid inwardly first will engage on the outwardly directed side edge 224 of the securement tab 42 and with longitudinal inward forcing of the plug member 200, the rear surface 228 of the catch arm 210 will be cammed to direct forwardly over the forward surface 25 of the securement tab 42 and/or over the head of any screw 44 against an inherent bias of the catch arm 210 and remaining deflected until the catch arm 210 is clear of the inwardly directed side edge 224 of the securement tab 42 whereupon the catch arm 210 will under its inherent bias snap into an engaged position on the inner side of the securement tab 42 assuming a position as, for example, illustrated in front view in FIG. 34, in side view in FIG. 35 and in rear view in FIG. 36. With the wall plate 10 secured to the wall 36 with the plug member 200 fixed in position straddling the securement tab 42, the dispenser and its back plate 14 may be secured to the wall plate 10 by the key member 46 extending through the keyway opening 38 in the normal manner since the channelway 206 of the plug member 200 is sized to not provide any interference. Similarly, in a normal manner, without interference with the plug member 200, the lock member 100 may be coupled and uncoupled in the keyway opening 38.

FIG. 37 illustrates a side view showing the relative location of each of the locking member 100, plug member 200 and the back plate 14 relative to the wall plate 10 as seen from the side in FIG. 12.

While the invention has been described with reference to preferred embodiments, many modifications and variations will now occur to persons skilled in the art. For a definition of the invention, reference is made to the following claims.

We claim:

1. A wall plate system comprising:
a wall plate adapted for securing to a wall by fastening mechanism selected from fasteners which extend rearwardly of the wall plate into the wall and adhesives,
a plurality of dispensers each of which are adapted to be removably coupled to the wall plate,
the wall plate having an upper edge, a lower edge, and two side edges,
the wall plate having a securement portion and a plate portion,
the securement portion disposed along the upper edge,
the plate portion coupled to the securement portion and extending therefrom between the two side edges to the lower edge,
the plate portion comprising a thin planar sheet member having a rear surface and a front surface,
the securement portion having a rear surface disposed in the same plane as the rear surface of the plate portion or forward thereof,
the securement portion carrying an engagement element,
the dispenser having an upper end, a lower end and a rear surface for engagement with forward surface of the plate portion,
the dispenser carrying at its upper end an engagement member removably engaging the engagement element of the securement portion to removably secure the dispenser to the wall plate with the rear surface of the dispenser in engagement with the forward surface of the plate portion with the upper end of the dispenser proximate the securement portion and with the dispenser extending downwardly from its upper end to its lower end,
wherein with the wall plate secured to a wall with a first of the dispensers coupled to the wall plate by engagement between the engagement element of the wall plate and the engagement member of that first dispenser, without removal or disengagement of the wall plate from the wall, the first dispenser is removable from the wall plate by disengagement of the engagement between the engagement element of the wall plate and the engagement member of that first dispenser for replacement as by a second of the plurality of dispensers by engagement between the engagement element of the wall plate and the engagement member of that second dispenser.

2. A wall plate system as claimed in claim 1 wherein the wall plate is a unitary element formed from a sheet of metal.

3. A wall plate system as claimed in claim 1 wherein the engagement element and the engagement member are complementary so as to provide for connection and disconnection by manipulating the relative position of the dispenser and its engagement member relative to the securement portion.

4. A wall plate system as claimed in claim 1 wherein the securement portion extends forwardly relative to the plate portion with the dispenser when coupled thereto supported in engagement between the engagement element and the engagement member to hang downwardly from the securement portion.

5. A wall plate system as claimed in claim 1 including a secondary engagement mechanism removably securing the lower end of the dispenser to the forward surface of the plate portion of the wall plate when the engagement element and the engagement member are engaged and release of the secondary engagement mechanism is required to disconnect the engagement element and the engagement member.

6. A wall plate system as claimed in claim 5 wherein the secondary engagement mechanism comprises a magnetic mechanism with the plate portion being magnetic and the dispenser carrying proximate its lower end a permanent magnet which is magnetically attracted to the plate portion underlying the magnet.

7. A wall plate system as claimed in claim 6 wherein each of the dispensers is removed from the wall plate and secured to the wall plate via relative coupling or uncoupling of the engagement element and the engagement member and coupling or uncoupling of the secondary engagement mechanism manually without the use of tools and without removing the wall plate from its securement to the wall.

8. A wall plate system as claimed in claim 1 wherein the secondary engagement mechanism comprises an adhesive between the rear surface of the dispenser and the forward surface of the plate portion, the adhesive adhering to the forward surface of the plate portion such that the bond may be broken by the application of forces between the plate portion and the dispenser and which adhesive may be removed from adherence to the plate portion.

9. A wall plate system as claimed in claim 1 wherein the securement portion comprises an elongate channel member extending along the upper edge of the wall plate defining a hollow channelway therein, the engagement element comprising a keyway opening through the channel member into the channel-way, the engagement member comprising a key member adapted to extend through the keyway at least partially into the channelway to couple the dispenser to the securement portion against removal with the dispenser to hang downwardly from the securement portion.

10. A wall plate system as claimed in claim 1 wherein the keyway and the key member engage each other to permit relative pivoting of the dispenser relative the wall plate about a pivot axis parallel to and proximate the upper edge of the wall plate without disengagement of the keyway and the key member.

11. A wall plate system as claimed in claim 1 wherein the engagement element and the engagement member engage each other to permit relative pivoting of the dispenser relative the wall plate about a pivot axis parallel to and proximate the upper edge of the wall plate.

12. A wall plate system as claimed in claim 1 wherein the securement portion includes openings for passage of fasteners through the securement portion into the wall to secure the wall plate to the wall.

13. A wall plate system as claimed in claim 1 wherein the dispenser includes a rear mounting plate removably coupled to the remainder of the dispenser, the rear mounting plate carrying at an upper end thereof the engagement element.

14. A wall plate system as claimed in claim 1 wherein the wall plate comprises a unitary piece of sheet metal folder at a juncture between the plate portion and the securement portion to provide the securement portion as extending forwardly from the plane of the plate portion.

15. A wall plate system as claimed in claim 10 wherein the keyway provides an opening with an upper passage portion open into and above a lower catch portion, the key member having a distal tab portion sized to pass through the upper passage portion and sized to not pass through the lower catch portion, the tab portion insertable into the keyway through the upper passage portion and then moved downwardly relative the keyway to be received relative the lower catch portion in a position which the tab portion and lower catch portion engage to prevent removal without upward movement of the dispenser.

16. A wall plate system as claimed in claim 1 including a lock member removably secured to the engagement member to prevent disengagement between the engagement element of the wall plate and the engagement member of the first dispenser.

17. A wall plate system as claimed in claim 9 including a lock member removably secured to the engagement member to prevent disengagement between the engagement element of the wall plate and the engagement member of the first dispenser,
the lock member removably secured in the keyway to block removal of the key member through the keyway.

18. A wall plate system as claimed in claim 15 including a lock member removably secured to the engagement member to prevent disengagement between the engagement element of the wall plate and the engagement member of the first dispenser,
the lock member removably secured in the upper passage portion to block removal of the key member through the keyway.

19. A wall plate system as claimed in claim 7 wherein the lock member has a rear surface engaging a forward surface of the channel member about the keyway and hook members which extend through the keyway into the channelway, at least one of the hook members being resiliently deflectable between a rest position in which the members secure the lock members in the keyway against removal and a withdrawn position in which the hook members do not prevent removal of the lock member from the keyway, the hook member biased to its rest position.

20. A wall plate system as claimed in claim 9 including a block member disposed within the channel member against removal while the wall plate is secured to a wall to prevent passage longitudinally through the channelway.

21. A wall plate system as claimed in claim 20 in which the block member straddles the keyway opening and with the key member extending through the keyway and into the channelway to couple the dispenser to the securement portion against removal, the lock member is prevented from being removed from the channelway by longitudinal sliding.

22. A wall plate system as claimed in claim 20 wherein the wall plate comprises a unitary piece of sheet metal folder at a juncture between the plate portion and the securement portion to provide the securement portion as extending forwardly from the plane of the plate portion,
the keyway extending from the juncture between the plate portion and the securement portion through the securement portion,
the wall plate including a securement tab centered rearward of the keyway as a planar extension of the plate portion upwardly past the junction;
the securement tab having lateral edges on each side thereof, the lock member straddling the securement tab engaging the lateral edges thereof to prevent longitudinal movement of the lock member in the channelway.

23. A wall plate system as claimed in claim 20 wherein the plug member is received within the channelway and having resilient means which biases the plug member into a friction fit between a wall to which the wall plate is to be secured and outwardly directly surfaces of the channel member.
